(19) United States
(12) Patent Application Publication
(10) Pub. No.: US 2025/0312740 A1
(43) Pub. Date: Oct. 9, 2025

(54) GASOLINE PARTICULATE FILTER

(71) Applicant: BASF CORPORATION, Florham Park, NJ (US)

(72) Inventors: Chunyu CHEN, Shanghai (CN); Yehui WU, Shanghai (CN); Attilio SIANI, Hannover (DE); Weiliang WANG, Shanghai (CN); Andreas GREMMINGER, Shanghai (CN); Stephan SIEMUND, Hannover (DE); Thomas SCHMITZ, Hannover (DE); Yoshinori TAKAHASHI, Tokyo (JP); Mahiro SHIROTORI, Tokyo (JP); Kazuma UEMURA, Tokyo (JP)

(21) Appl. No.: 18/873,115

(22) PCT Filed: Jun. 8, 2023
(86) PCT No.: PCT/CN2023/099161

§ 371 Date: Dec. 9, 2024

(30) Foreign Application Priority Data
Jun. 9, 2022 (WO) PCT/CN2022/097910

(51) Int. Cl. B01D 53/94; B01J 21/04; B01J 23/58; B01J 35/57; B01J 37/02; B01J 37/08; F01N 3/10

(52) U.S. Cl. CPC B01D 53/9454; B01J 21/04; B01J 23/58; B01J 35/57; B01J 37/0213; B01J 37/08; F01N 3/101; B01D 2255/1025; B01D 2255/9155; B01D 2258/01

(57) ABSTRACT

The present invention relates to a particulate filter, which comprises a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels f that are closed at the inlet end and open at the outlet end; and a layer of inorganic particles loaded on surfaces of porous walls in the inlet channels and/or outlet channels, wherein the layer of inorganic particles comprises inorganic particles of needle-like crystals. The f present invention also relates to a method for producing a particulate filter which includes applying inorganic particles or precursors thereof on surfaces of porous walls in the inlet channels and/or outlet channels wherein at least part of the inorganic particles or precursors thereof are particles of needle-like crystals.

### FIELD OF THE INVENTION

The present invention relates to a particulate filter for treatment of an exhaust stream from a gasoline engine, which comprises an inorganic powder particle coating. The present invention also relates to a gasoline engine emission treatment system comprising the particulate filter and a method for treating an exhaust stream from a gasoline engine.

### BACKGROUND OF THE INVENTION

Engine exhaust substantially consists of gaseous pollutants such as unburned hydrocarbons (HC), carbon monoxide (CO) and nitrogen oxides (NOx), and particulate matter (PM). For gasoline engines, three-way conversion catalysts (hereinafter interchangeably referred to as TWC catalyst or TWC) for gaseous pollutants and filters for particulate matter (PM) are well-known emission aftertreatment means to ensure the exhaust emission to meet emission regulations.

In contrast to particulates generated by diesel lean burning engines, particulates generated by gasoline engines, such as Gasoline Direct Injection engines, tend to be finer and in lesser quantities. This is due to different combustion conditions of gasoline engines as compared to diesel engines. Also, hydrocarbon components are different in the emissions of gasoline engines as compared to diesel engines. Particulate filters specific for gasoline engines have been developed for a few decades in order to effectively treating the engine exhausts from gasoline engines.

For example, WO 2018/024547A1 describes a catalyzed particulate filter comprising a TWC catalytic material permeating walls of a particulate filter. Coating a TWC catalytic material onto or within a filter may result in an impact of back pressure. A particular coating scheme was proposed in the patent application to avoid unduly increasing back pressure while providing full three-way conversion functionality. It is required that the catalyzed particulate filter has a coated porosity that is less than an uncoated porosity of the particulate filter.

WO2018/115900A1 describes a particulate filter for use in an emission treatment system of a gasoline engine, which has an inlet side and an outlet side, wherein at least the inlet side is loaded with a synthetic ash comprising one or more of aluminium oxide, zinc oxide, zinc carbonate, calcium oxide, calcium carbonate, cerium zirconium (mixed) oxide, zirconium oxide, cerium oxide and hydrated alumina. It is described that the particle distribution may help to prevent a significant amount of the synthetic ash from entering the pores of the porous substrate.

It is known that gasoline particulate filter filtration performance will improve over the lifetime of the filter, primarily as a result of ash and soot accumulation on the walls of the inlet sides in the filter. Also, it was identified that particulate number of an emission generated during the cold start phase of a test cycle represents the primary portion of the total particles emitted during the test. Therefore, the particle filtration performance at the initial filtration phase, also called fresh filtration efficiency, is a main concern for developing gasoline particulate filters.

As particulate emissions from gasoline engines are being subject to more stringent regulations, such as Euro 6 and China 6, the vehicle manufacturers, i.e., original equipment manufacturers (OEMs) require gasoline particulate filters to have high fresh filtration efficiency with a desirable low back pressure.

There is a need to provide an improved particulate filter for treatment of an exhaust stream from a gasoline engine, which could provide a higher fresh filtration efficiency under a relatively low back pressure.

### SUMMARY OF THE INVENTION

The object of the present invention is to provide a particulate filter for treatment of an exhaust stream from a gasoline engine, which provides a higher fresh filtration efficiency, without suffering an unacceptable back pressure increase.

It has been surprisingly found that the object of the present invention was achieved by a particulate filter comprising a layer of inorganic particles comprising particles having a needle-like morphology in inlet channels and/or outlet channels of the filter.

Accordingly, in a first aspect, the present invention provides a particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in the inlet channels and/or outlet channels,
   wherein the layer of inorganic particles comprises inorganic particles of needle-like crystals.

In a second aspect, the present invention provides a method for producing a particulate filter, which includes
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end,
applying inorganic particles or precursors thereof on surfaces of porous walls in the inlet channels and/or outlet channels, wherein at least part of the inorganic particles or precursors thereof are particles of needle-like crystals, and
optionally, drying and/or calcining.

In a third aspect, the present invention provides an exhaust treatment system comprising a particulate filter as described in the first aspect or a particulate filter obtainable or obtained from the method as described in the second aspect, which is located downstream of a gasoline engine.

In a fourth aspect, the present invention provides a method for treating an exhaust stream from a gasoline engine, which includes contacting the exhaust stream with a particulate filter as described in the first aspect, a particulate filter obtainable or obtained from the method as described in the second aspect or an exhaust treatment system as described in the third aspect.

It has been found that the particulate filter for treatment of an exhaust gas from a gasoline engine, also referred to as gasoline particulate filter herein, could provide an improved fresh filtration efficiency compared with prior art counterparts, while no significant back pressure increase was observed.

### BRIEF DESCRIPTION OF THE DRAWINGS

FIG. 1 illustrates an external view of a wall-flow substrate having an inlet end and an outlet end.

FIG. 2 illustrates a longitudinal sectional view of an exemplary wall-flow substrate having a plurality of porous walls extending longitudinally from an inlet end to an outlet end of the substrate.

FIGS. 3A and 3B show SEM images of the material A as used in Comparative Examples 1, 2 and 3, with 5K and 10K magnifications respectively.

FIGS. 4A and 4B show SEM images of the material B as used in Inventive Examples 1, 3 and 4, with 5K and 10K magnifications respectively.

FIGS. 5A and 5B show SEM images of the material C as used in Inventive Example 2, with 5K and 10K magnifications respectively.

### DETAILED DESCRIPTION OF THE INVENTION

The present invention will be described in detail hereinafter. It is to be understood that the present invention may be embodied in many different ways and shall not be construed as limited to the embodiments set forth herein.

The singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or cognates may be embraced within “comprises” or cognates.

Herein, the term “layer”, for example within the context of the layer of inorganic particles, is intended to mean a thin gas-permeable coating of materials carried on blank or pre-coated walls of a substrate. The layer may be in form of packed particles on walls of the substrate with gaps therebetween allowing for gas to permeate through.

The terms “D₁₀”, “D₅₀” and “D₉₀” have their usual meanings, referring to the points where the cumulative volume from the small-particle-diameter side reaches 10%, 50% and 90% in the cumulative particle size distribution respectively. The particle size distribution is measured by using a laser diffraction particle size distribution analyzer.

The terms for platinum group metal (PGM) components, such as “palladium component”, “platinum component” and “rhodium component” are intended to describe the presence of respective platinum group metals in any possible valence state, which may be for example metal or metal oxide as the catalytically active form, or may be for example metal compound, complex or the like which, upon calcination or use of the catalyst, decomposes or otherwise converts to the catalytically active form.

The term “support” refers to a material in form of particles, for receiving and carrying one or more platinum group metal (PGM) components, and optionally one or more other components such as stabilizers, promoters and binders.

The term “needle-like” is intended to refer to a crystalline morphology approximating a spindle- or needle-shaped crystal having a major axis length (i.e., crystal length) and a minor axis length (i.e., crystal thickness) such that the crystal length is much higher, generally at least 3 times higher than the crystal thickness. For example, the ratio of crystal length to crystal thickness may be in the range of from 3 to 60, from 5 to 40, or from 8 to 30.

The term “particles of needle-like crystals” refers to particles which are aggregates or agglomerates of needle-like crystals and may also comprise single needle-like crystals.

Herein, any reference to an amount of loading in the unit of “g/ft³” or “g/in³” is intended to mean the weight of the specified component, coat or layer per unit volume of the substrate or substrate part, on which they are carried.

According to the first aspect of the present invention, a particulate filter is provided, which comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in the inlet channels and/or outlet channels,
   wherein the layer of inorganic particles comprises inorganic particles of needle-like crystals.

The substrate as used herein refers to a structure that is suitable for withstanding conditions encountered in an exhaust stream from combustion engines, which can function as a particulate filter by itself, and can also carry functional materials, for example a filtration-improving layer such as a layer of inorganic particles as described herein, and optionally any other layer.

The substrate comprises a plurality of porous walls extending longitudinally to form a plurality of parallel channels extending from an inlet end to an outlet end, wherein a quantity of the channels being inlet channels that are open at the inlet end and closed at the outlet end, and a quantity of channels different from the inlet channels are outlet channels that are closed at the inlet end and open at the outlet end. The configuration of the substrate, also referred to as wall-flow substrate, requires the engine exhaust in the inlet channels flows through the porous walls into the outlet channels to reach the outlet end of the substrate.

Generally, the substrate may exhibit a honeycomb structure with alternate channels being blocked with a plug at opposite ends.

The porous walls of the substrate are generally made from ceramic materials or metal materials. Suitable ceramic materials useful for constructing the substrate may include any suitable refractory material, e.g., cordierite, mullite, cordierite-alumina, silicon carbide, silicon nitride, zirconia, mullite, spodumene, alumina-silica-magnesia, zirconium silicate, magnesium silicates, sillimanite, petalite, alumina, aluminium titanate and aluminosilicates. Typically, the porous walls of the substrate are made from cordierite or silicon carbide.

Suitable metallic materials useful for constructing the substrate may include heat resistant metals and metal alloys such as titanium and stainless steel as well as other alloys in which iron is a substantial or major component. Such alloys may contain one or more of nickel, chromium and aluminium, and the total amount of these metals may advantageously comprise at least 15% by weight of the alloy, for example 10 to 25% by weight of chromium, 3 to 8% by weight of aluminium, and up to 20% by weight of nickel. The alloys may also contain small or trace amounts of one or more metals such as manganese, copper, vanadium, titanium and the like. The surface of the metallic substrate may be oxidized at high temperature, e.g., 1000° C. or higher, to form an oxide layer on the surface of the substrate, improving the corrosion resistance of the alloy and facilitating adhesion of any coat layer to the metal surface.

The channels at the closed ends are blocked with plugs of a sealant material. Any suitable sealant materials may be used without being limited.

The channels of the substrate can be of any suitable cross-sectional shape and size, such as circular, oval, triangular, rectangular, square, hexagonal, trapezoidal or other polygonal shapes. The substrate may have up to 700 channels (i.e. cells) per square inch of cross section. For example, the substrate may have 100 to 500 cells per square inch (“cpsi”), typically 200 to 400 cpsi. The walls of the substrate may have various thicknesses, with a typical range of 2 mils to 0.1 inches. Preferably, the substrate has a number of inlet channels that is equal to the number of outlet channels, and the channels are evenly distributed throughout the substrate.

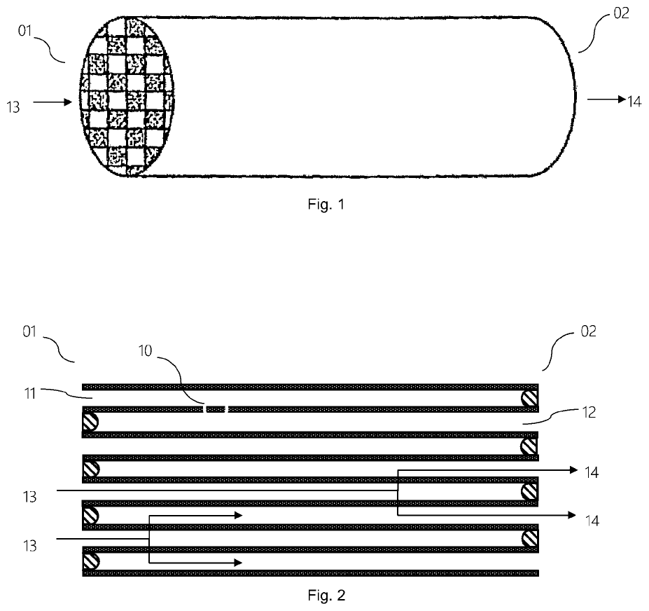

FIGS. 1 and 2 illustrate a typical wall-flow substrate comprising a plurality of inlet and outlet channels.

FIG. 1 depicts an external view of the wall-flow substrate having an inlet end (01) from which an exhaust stream (13) enters the substrate and an outlet end (02) from which the exhaust having been treated exits. Alternate channels are blocked with plugs to form a checkerboard pattern at the inlet end (01) as shown and an opposing checkerboard pattern at the outlet end (02) which is not shown.

FIG. 2 schematically depicts a longitudinal sectional view of the wall-flow substrate, comprising a first plurality of channels (11) which are open at the inlet end (01) and closed at the outlet end (02), and a second plurality of channels (12) which are open at the outlet end (02) and closed at the inlet end (01). The channels are preferably parallel to each other to provide a constant wall thickness between the channels. The exhaust stream entering the first plurality of channels from the inlet end cannot leave the substrate without diffusing through the porous walls (10) into the second plurality of channels.

The particulate filter according to the present invention may comprise the layer of inorganic particles loaded on surfaces of the porous walls in the inlet channels and/or outlet channels. In other words, the layer of inorganic particles may be loaded on the porous walls in the inlet channels alone, in the outlet channels alone or in both inlet channels and outlet channels.

Particularly, the layer of inorganic particles may be loaded on the porous walls in the inlet channels alone or in both inlet channels and outlet channels, more preferably in the inlet channels alone.

It will be appreciated that the layer of inorganic particles is intended to be loaded onto surfaces of the porous walls in the inlet and/or outlet channels, which is also referred to as “on-wall” coat, while a minor amount of inorganic particles may infiltrate into the pores within the porous walls.

According to the present invention, the inorganic particles may be particles of a non-PGM inorganic material. The non-PGM inorganic material may be for example alumina, hydrated alumina, boehmite, zirconia, ceria, silica, titania, magnesium oxide, zinc oxide, zinc carbonate, calcium oxide, calcium carbonate, silicate zeolite, aluminosilicate zeolite, or a combination or composite thereof.

Accordingly, the inorganic particles of needle-like crystals may be particles of needle-like crystals of a non-PGM inorganic material selected from alumina, hydrated alumina, boehmite, zirconia, ceria, silica, titania, magnesium oxide, zinc oxide, zinc carbonate, calcium oxide, calcium carbonate, silicate zeolite, aluminosilicate zeolite, or a combination or composite thereof.

Preferably, the inorganic particles, particularly the inorganic particles of needle-like crystals are particles of a non-PGM inorganic material selected from alumina, hydrated alumina, boehmite, silica, zinc oxide, zirconia, or a combination or composite thereof, more preferably, alumina, boehmite or any combinations thereof.

The layer of inorganic particles may optionally comprise a PGM component, such as palladium component and/or platinum component. The PGM component, if present, may be supported on particles of the non-PGM inorganic material as mentioned above, or may be present separate from particles of the non-PGM inorganic material of needle-like crystals.

Herein, the layer of inorganic particles loaded on the porous walls in the inlet and/or outlet channels of the substrate particularly refers to a layer exhibiting minor or no, preferably no TWC activity, although it may exhibit a certain catalytic activity if one or more PGM components are comprised in the inorganic particles.

In some embodiments, the layer of inorganic particles does not comprise a PGM component. Preferably, the layer of inorganic particles may mainly or substantially consist of inorganic particles having needle-like crystals of a non-PGM inorganic material selected from alumina, hydrated alumina, boehmite, zirconia, ceria, silica, titania, magnesium oxide, zinc oxide, zinc carbonate, calcium oxide, calcium carbonate, silicate zeolite, aluminosilicate zeolite, or a combination or composite thereof, among which alumina, hydrated alumina, boehmite, silica, zinc oxide, zirconia, or a combination or composite thereof is more preferable, and alumina and boehmite are most preferably.

Herein, any reference to “mainly consist of” within the context of the layer of inorganic particles is intended to mean the layer of inorganic particles comprise a major amount, i.e., more than 50% by volume, of the inorganic particles of needle-like crystals as specified, which may be for example 75% by volume or higher, 85% by volume or higher, 90% by volume or higher, or even 95% by volume or higher.

Herein, any reference to “substantially consist of” within the context of the layer of inorganic particles is intended to mean the layer of inorganic particles comprises a non-intentionally added amount of inorganic particles other than the inorganic particles of needle-like crystals as specified. Herein, the term “non-intentionally added amount” is intended to refer to no more than 1% by volume, no more than 0.5% by volume, no more than 0.1% by volume or no more than 0.05 by volume.

It has been found by the inventors that the needle-like crystal morphology of the inorganic particles has an advantageous impact on the fresh filtration efficiency and/or back pressure of the particulate filters.

The needle-like crystals may have a crystal length of no more than 20 microns (μm), no more than 10 μm, or no more than 8 μm, as measured by a scanning electron microscope (SEM). Additionally, the needle-like crystals may have a crystal thickness of no more than 1000 nanometers (nm), no more than 500 nm, or no more than 300 nm, as measured by a scanning electron microscope (SEM).

In some embodiments, the needle-like crystals may have a crystal length of no more than 20 μm and a crystal thickness of no more than 1000 nm, preferably a crystal length of no more than 10 μm and a crystal thickness of no more than 500 nm, more preferably a crystal length of no more than 8 μm and a crystal thickness of no more than 300 nm.

The inorganic particles, particularly the inorganic particles of needle-like crystals, useful for the present invention may have a D₉₀ of no more than 50 microns (μm), no more than 30 μm, or no more than 20 μm. The inorganic particles, particularly the inorganic particles of needle-like crystals, useful for the present invention may have a D₅₀ in the range of from 3 to 20 μm, from 3 to 15 μm, or from 5 to 10 μm. The inorganic particles, particularly the inorganic particles of needle-like crystals, useful for the present invention may have a D₁₀ of no more than 8 μm, no more than 5 μm, or no more than 2 μm.

The particulate filter according to the present invention may comprise the layer of inorganic particles at a loading of from 0.005 to 0.83 g/in³ (i.e., about 0.3 to 50 g/L), from 0.01 to 0.33 g/in³ (i.e., about 0.6 to 20 g/L), or from 0.015 to 0.1 g/in³ (i.e., about 0.9 to 6 g/L).

The layer of inorganic particles may be applied onto the surfaces of the porous walls of the substrate by any known processes, such as dry coating process and washcoating process.

The dry coating process is well-known and generally carried out by blowing inorganic particles or suitable precursors thereof in particulate form by means of a carrier gas stream into channels of a substrate from the open ends, optionally drying and optionally calcining the coated substrate.

By this process, no liquid carrier will be used. The inorganic particles are typically distributed on the surfaces of the porous walls of the channels in form of particle beds.

It will be appreciated that inorganic particles or suitable precursors thereof as applied will maintain their crystalline morphology after calcining the coated substrate. In other words, the calcining, if carried out, will not result in a change of the crystalline morphology of the inorganic particles.

In some embodiments, the inorganic particles or suitable precursors thereof may be blown into the inlet channels from the open ends towards the closed ends of the channels. The formed particle beds in the inlet channels may be located on the porous walls of the inlet channels, and also against the plug blocking the channels. The particle beds, i.e., the layer of inorganic particles is gas-permeable, which can contribute to trapping particulate matter (PM) of the exhaust stream and allow gaseous pollutants of the exhaust stream to permeate therethrough.

The layer of inorganic particles in form of particle beds may extend along the porous walls of the channels where the inorganic particles are loaded. It will be appreciated that the particle beds may extend along the entire length of the porous walls of the channels, or along only a part of the length of the porous walls of the channels.

The washcoating process is also well-known and generally carried out by coating a slurry comprising the inorganic particles or suitable precursors thereof and optional auxiliaries in a liquid solvent (e.g. water) into channels of a substrate from the open ends, drying and optionally calcining the coated substrate. The layer of inorganic particles applied by washcoating may be in the form of a porous coating, which may extend along the porous walls of the channels where the inorganic particles are loaded. Also, the porous coating may extend along the entire length of the porous walls of the channels, or along only a part of the length of the porous walls of the channels.

The particulate filter according to the present invention may further comprise a TWC coat in at least a portion of the inlet channels and/or outlet channels of the substrate. Particularly, the TWC coat is present in both inlet channels and outlet channels of the substrate.

The TWC coat is typically in form of a washcoat comprising a TWC composition, also referred to as “in-wall” coat.

It will be appreciated that the TWC coat is intended to be loaded in pores of the porous walls of the channels, while an appreciable amount of TWC composition may also be found on the surfaces of the porous walls in the coated channels.

There is no particular restriction to the TWC composition useful for the TWC coat comprised in the particulate filter. Typically, the TWC composition comprises platinum group metal components as catalytically active species, e.g., rhodium component and one or both of platinum component and palladium component, which are supported on support particles. Useful materials as the support may be refractory metal oxides, oxygen storage components and any combinations thereof.

Examples of the refractory metal oxide may include, but are not limited to alumina, lanthana doped alumina, baria doped alumina, ceria doped alumina, zirconia doped alumina, ceria-zirconia doped alumina, Ianthana-zirconia doped alumina, baria-lanthana doped alumina, baria-ceria doped alumina, baria-zirconia doped alumina, baria-lanthana-neodymia doped alumina, lanthana-ceria doped alumina, and any combinations thereof.

Examples of the oxygen storage component (OSC) may include, but are not limited to reducible rare earth metal oxides, such as ceria. The oxygen storage component may also comprise one or more of lanthana, praseodymia, neodymia, europia, samaria, ytterbia, yttria, zirconia and hafnia to constitute a composite oxide with ceria. Particularly, the oxygen storage component is selected from ceria-zirconia composite oxide and stabilized ceria-zirconia composite oxide.

The particulate filter according to the present invention may comprise the TWC coat at a loading of 0.1 to 5.0 g/in³ (i.e., about 6.1 to 305.1 g/L), or 0.5 to 3.0 g/in³ (i.e., about 30.5 to 183.1 g/L), or 0.8 to 2 g/in³ (i.e., about 49 to 122 g/L).

The TWC coat may comprise the PGM components at a total loading of 1.0 to 50.0 g/ft³ (i.e., about 0.04 to 1.8 g/L), or 5.0 to 20.0 g/ft³ (i.e., about 0.18 to 0.71 g/L), calculated as respective PGM elements.

The TWC coat may be applied onto the substrate by any known processes, typically by a washcoating process. The washcoating process is generally carried out by coating a slurry comprising TWC catalyst particles of supported PGM components and optionally auxiliaries in a solvent (e.g. water), drying and calcining the coated substrate.

The TWC coat, when present, will be applied onto the substrate before loading the layer of inorganic particles as described hereinabove. The TWC coat, when present, may also be referred to as an under-layer coat, i.e., being under the layer of inorganic particles.

In some illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a TWC coat, preferably a washcoat comprising a TWC composition,
   wherein the layer of inorganic particles comprises inorganic particles of needle-like crystals.

In further illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the layer of inorganic particles comprises inorganic particles of needle-like crystals in an amount of 75% by volume or higher, 85% by volume or higher, 90% by volume or higher, or even 95% by volume or higher, based on the total volume of all inorganic particles in the layer of inorganic particles.

In some other illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the layer of inorganic particles mainly or substantially consists of inorganic particles of needle-like crystals of a non-PGM inorganic material.

In some further illustrative embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the layer of inorganic particles mainly or substantially consists of inorganic particles of needle-like crystals of a non-PGM inorganic material selected from alumina, hydrated alumina, boehmite, silica, zinc oxide, zirconia, or a combination or composite thereof.

In some particular embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the layer of inorganic particles mainly or substantially consists of inorganic particles of needle-like crystals of a non-PGM inorganic material selected from alumina, hydrated alumina, boehmite, silica, zinc oxide, zirconia, or a combination or composite thereof, and wherein the needle-like crystals have a crystal length of no more than 20 μm and a crystal thickness of no more than 1000 nm.

In some preferable particular embodiments, the particulate filter according to the present invention comprises,
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in at least the inlet channels, and
optionally a washcoat comprising a TWC composition,
   wherein the layer of inorganic particles mainly or substantially consists of inorganic particles of needle-like crystals of a non-PGM inorganic material selected from alumina, hydrated alumina, boehmite, silica, or a combination or composite thereof, and wherein the needle-like crystals have a crystal length of no more than 10 μm and a crystal thickness of no more than 500 nm, more preferably a crystal length of no more than 8 μm and a crystal thickness of no more than 300 nm.

In each of those illustrative and particular embodiments as described above, it is preferred that the inorganic particles substantially consist of inorganic particles of needle-like crystals having at least one, preferably all, of following particle size characteristics,
D₉₀ of no more than 30 μm,
D₅₀ of 3 to 15 μm, and
D₁₀ of no more than 5 μm.

It is more preferred that the inorganic particles substantially consist of inorganic particles of needle-like crystals having at least one, preferably all, of following particle size characteristics,
D₉₀ of no more than 20 μm,
D₅₀ of 5 to 10 μm, and
D₁₀ of no more than 2 μm.

In those illustrative and particular embodiments as described above, it is preferred that the layer of inorganic particles does not comprise a PGM component.

In those illustrative and particular embodiments as described above, it is preferred that the particulate filter comprises a washcoat comprising a TWC composition.

The particulate filter may be housed within a shell having an inlet and an outlet for an exhaust stream, that may be operatively associated and in fluid communication with other parts of an exhaust system of an engine.

According to the second aspect of the present invention, a method for producing a particulate filter is provided, which includes,
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end,
applying inorganic particles or precursors thereof on surfaces of porous walls in the inlet channels and/or outlet channels, wherein at least part of the inorganic particles or precursors thereof are particles of needle-like crystals, and
optionally, drying and/or calcining.

The inorganic particles or precursors thereof may be applied on the surfaces of the porous walls by a dry coating or washcoating process as described hereinabove in the first aspect, preferably a dry coating process.

In some embodiments, the method for producing a particulate filter further includes applying a TWC coat in the porous walls in at least a portion of the inlet and/or outlet channels of the substrate before applying the inorganic particles on surfaces of the porous walls. The TWC coat may be applied by a washcoating process as described hereinabove.

Any general description and preferences described hereinabove for the layer of inorganic particles and the TWC coat in the first aspect are applicable here by reference.

In some embodiments, more than 50% by volume of the inorganic particles as applied, for example 75% by volume or higher, 85% by volume or higher, 90% by volume or higher, or even 95% by volume or higher, are inorganic particles of needle-like crystals as specified herein.

Particularly, the inorganic particles as applied substantially consist of inorganic particles of needle-like crystals.

According to the third aspect, an exhaust treatment system is provided, which comprises a particulate filter as described in the first aspect or a particulate filter obtainable or obtained from the method as described in the second aspect, which is located downstream of a gasoline engine.

According to the fourth aspect, a method for treating an exhaust stream from a gasoline engine is provided, which includes contacting the exhaust stream with a particulate filter as described in the first aspect, a particulate filter obtainable or obtained from the method as described in the second aspect or an exhaust treatment system as described in the third aspect.

### Embodiments

Various embodiments are listed below. It will be understood that the embodiments listed below may be combined with all aspects and other embodiments in accordance with the scope of the invention.

Embodiment 1. A particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in the inlet channels and/or outlet channels, preferably in at least the inlet channels,
   wherein the layer of inorganic particles comprises inorganic particles of needle-like crystals.

Embodiment 2. The particulate filter according to Embodiment 1, wherein the layer of inorganic particles comprises the inorganic particles of needle-like crystals in an amount of 50% by volume or higher, 75% by volume or higher, 85% by volume or higher, 90% by volume or higher, or even 95% by volume or higher.

Embodiment 3. The particulate filter according to Embodiment 2, wherein the layer of inorganic particles substantially consists of the inorganic particles of needle-like crystals.

Embodiment 4. The particulate filter according to any of preceding Embodiments, wherein the layer of inorganic particles exhibits no three-way conversion catalytic activity.

Embodiment 5. The particulate filter according to any of preceding Embodiments, wherein the layer of inorganic particles does not comprise a PGM component.

Embodiment 6. The particulate filter according to any of preceding Embodiments, wherein the inorganic particles, particularly the inorganic particles of needle-like crystals are particles of a non-PGM inorganic material, particularly selected from alumina, hydrated alumina, boehmite, zirconia, ceria, silica, titania, magnesium oxide, zinc oxide, zinc carbonate, calcium oxide, calcium carbonate, silicate zeolite, aluminosilicate zeolite, or a combination or composite thereof.

Embodiment 7. The particulate filter according to Embodiment 6, wherein the non-PGM inorganic material is selected from alumina, hydrated alumina, boehmite, silica, zinc oxide, zirconia, or a combination or composite thereof.

Embodiment 8. The particulate filter according to any of preceding Embodiments, wherein the needle-like crystals have a crystal length of no more than 20 μm, no more than 10 μm, or no more than 8 μm, as measured by a scanning electron microscope (SEM).

Embodiment 9. The particulate filter according to any of preceding Embodiments, wherein the needle-like crystals have a crystal thickness of no more than 1000 nm, no more than 500 nm, or no more than 300 nm, as measured by a scanning electron microscope (SEM).

Embodiment 10. The particulate filter according to any of preceding Embodiments, wherein the inorganic particles, particularly the inorganic particles of needle-like crystals, have a D₉₀ of no more than 50 microns (μm), no more than 30 μm, or no more than 20 μm.

Embodiment 11. The particulate filter according to any of preceding Embodiments, which further comprises a three-way conversion catalyst (TWC) coat, preferably a washcoat comprising a TWC composition.

Embodiment 12. The particulate filter according to Embodiment 11, wherein the three-way conversion catalyst coat is in at least a portion of the inlet channels and/or outlet channels of the substrate.

Embodiment 13. The particulate filter according to any of preceding Embodiments, which comprises the layer of inorganic particles at a loading of from 0.3 to 50 g/L, from 0.6 to 20 g/L, or 0.9 to 6 g/L.

Embodiment 14. The particulate filter according to any of preceding Embodiments, which is a gasoline particulate filter.

Embodiment 15. A method for producing a particulate filter as defined in any of Embodiments 1 to 14, which includes
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end,
applying inorganic particles or precursors thereof on surfaces of porous walls in the inlet channels and/or outlet channels, wherein at least part of the inorganic particles or precursors thereof are particles of needle-like crystals, and
optionally, drying and/or calcining.

Embodiment 16. The method according to Embodiment 15, wherein the inorganic particles are applied by a dry coating or washcoating process, preferably by a dry coating process.

Embodiment 17. An exhaust treatment system, which comprises a particulate filter according to any of Embodiments 1 to 14 or a particulate filter obtainable or obtained from the method according to any of Embodiments 13 to 16, and is located downstream of a gasoline engine.

Embodiment 18. A method for treating an exhaust stream from a gasoline engine, which includes contacting the exhaust stream with a particulate filter according to any of Embodiments 1 to 14, a particulate filter obtainable or obtained from the method according to any of Embodiments 15 to 16, or an exhaust treatment system as defined in Embodiment 17.

### Examples

Aspects of the present invention are more fully illustrated by the following examples, which are set forth to illustrate certain aspects of the present invention and are not to be construed as limiting thereof.

### I. Preparation of Particulate Filter

### Materials and Characterizations

Materials used for preparing the layer of inorganic particles of the particulate filters in Examples are summarized in Table 1 below. Particle sizes were measured by a Sympatec HELOS laser diffraction particle size analyzer. Surface area and pore volume were measured by a Micromeritics ASAP 2420 surface area and porosity analyzer with BET model under 77K nitrogen adsorption. Morphology and crystal size were determined by a Zeiss Supra 55 scanning electron microscope (SEM).

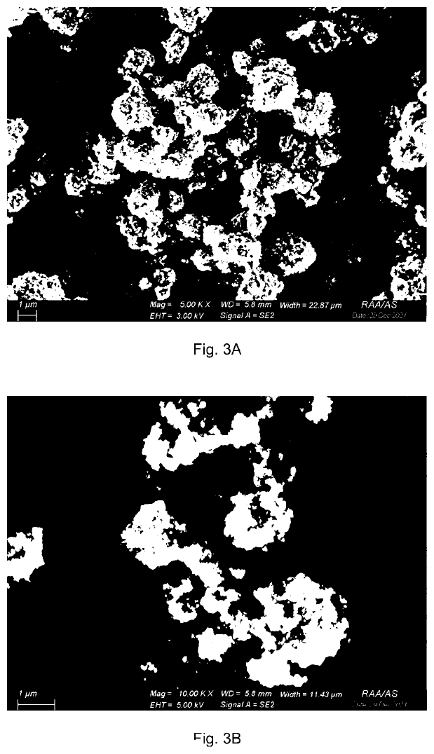

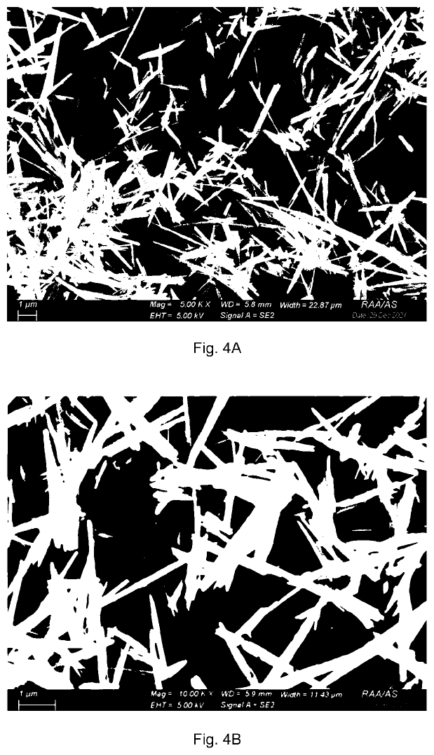

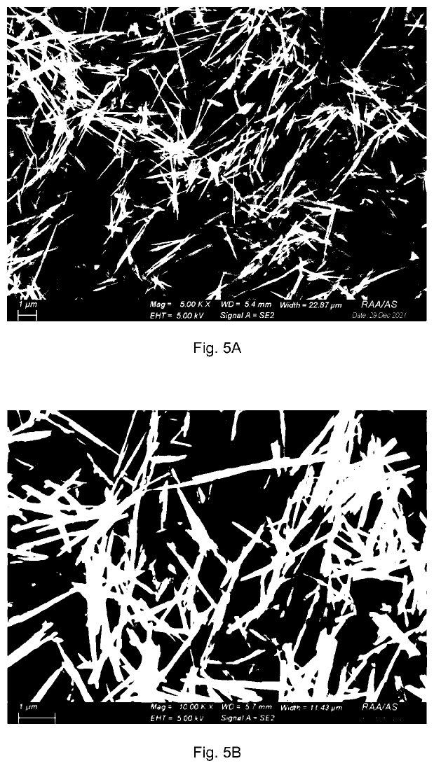

TABLE 1

| | Particle sizes | | | Surface | Pore | |
|---|---|---|---|---|---|---|
| | (μm) | | | area | volume | |
| Material | D₁₀ | D₅₀ | D₉₀ | (m²/g) | (cm³/g) | Morphology** |
| A, | 1.03 | 2.33 | 4.31 | 150 | 0.67 | Irregular, agglomeration of small spherical |
| alumina | | | | | | particles, as shown in FIG. 3A (5K Mag.) and FIG. |
| powder | | | | | | 3B (10K Mag.) |
| B, | 1.77 | 7.80 | 14.34 | 33 | 0.05 | Needle-like, crystal size of 2 to 6 μm in length and |
| boehmite* | | | | | | 100 to 200 nm in thickness, as shown in FIG. 4A |
| powder | | | | | | (5K Mag.) and FIG. 4B (10K Mag.) |
| C, | 1.94 | 7.21 | 13.89 | 210 | 0.15 | Needle-like, crystal size of 2 to 6 μm in length and |
| alumina | | | | | | 100 to 200 nm in thickness, as shown in FIG. 5A |
| powder | | | | | | (5K Mag.) and FIG. 5B (10K Mag.) |

*an aluminium oxide hydroxide, which will be converted to alumina upon calcination
**It was determined by SEM that the morphologies maintained after calcination of the materials A, B and C at 550° C.

### Reference Example 1 (R1)

A gasoline particulate filter cordierite substrate S1 was used as a reference filter (blank filter), which has a size of 118.4 mm (D)×127 mm (L), a volume of 1.4 L (about 85.4 in³), a cell density of 300 cells per square inch (cpsi), a wall thickness of 8 mils, a porosity of 65% as determined by a mercury intrusion measurement.

### Reference Example 2 (R2)

A particulate filter having a TWC coat was prepared from a filter substrate which is the same as the blank filter of Reference Example 1 (substrate S1), by applying a TWC washcoat into both inlet channels and outlet channels of the blank filter.

24.21 g of 9.68 wt % aqueous rhodium nitrate solution was impregnated in a planetary mixer (P-mixer) onto 255 g of a high surface area gamma alumina powder to form a wet powder while achieving incipient wetness. 14.37 g of 16.31 wt % aqueous hexahydroxy platinic acid diethanolamine salt solution was impregnated in planetary mixer (P-mixer) onto 712 g of a ceria/zirconia (40% ceria) composite powder to form a wet powder while achieving incipient wetness. An aqueous slurry was formed by mixing above two wet powders with 1124 g of D.I. water, to which 78 g of barium nitrate and 68 g of 21.3 wt % aqueous zirconium nitrate solution were added. The pH of the slurry was adjusted to 3.6 with nitric acid. The slurry was milled to a particle size Do of 4.5 μm, and then coated into the inlet channels of the blank filter with 50% of the washcoat loading and into the outlet channels of the blank filter with the rest 50% of the washcoat loading. Then, the coated substrate was dried at a temperature of 150° C. for 1 hour and then calcined at a temperature of 550° C. for 1 h.

The in-wall TWC coat was obtained with a washcoat loading of about 1.23 g/in³ (75 g/L) and a total PGM loading of about 10.0 g/ft³ (0.35 g/L) with a Pt/Rh ratio of 5/5.

### Reference Example 3 (R3)

A particulate filter having a TWC coat was prepared by applying the same process as described in Reference Example 2, except that a cordierite substrate S2 as the blank filter was used which has a size of 143.8 mm (D)×152.4 mm (L), a volume of 2.48 L (about 151.3 in³), a cell density of 300 cells per square inch (cpsi), a wall thickness of 8 mils, a porosity of 65% as determined by a mercury intrusion measurement.

### Comparative Example 1 (C1)

A particulate filter having a TWC coat and a layer of inorganic particles having irregular shape was prepared.

A particulate filter having a TWC coat was firstly prepared by applying the same process as described in Reference Example 2 on the same blank filter as described in Reference Example 1. Then, the material A, alumina powder, was mixed with a carrier gas and blown into the inlet channels of the filter at a flow rate of 600 m³/h at room temperature. After coating, the filter with the layer of inorganic particles in the inlet channels was calcined at a temperature of 550° C. for 1 hour. The loading of the layer of inorganic particles was 5 g/L (0.082 g/in³).

### Comparative Example 2 (C2)

A particulate filter having a TWC coat and a layer of inorganic particles having irregular shape was prepared.

A particulate filter having a TWC coat was firstly prepared by applying the same process as described in Reference Example 2 on the same blank filter as described in Reference Example 3. Then, the material A, alumina powder, was mixed with a carrier gas and blown into the inlet channels of the filter at a flow rate of 600 m³/h at room temperature. After coating, the filter with the layer of inorganic particles in the inlet channels was calcined at a temperature of 550° C. for 1 hour. The loading of the layer of inorganic particles was 1 g/L (0.016 g/in³).

### Comparative Example 3 (C3)

A particulate filter having a TWC coat and a layer of inorganic particles having irregular shape was prepared.

The preparation of the particulate filter was the same as Comparative Example 2, except that the loading of the layer of inorganic particles was 2 g/L (0.033 g/in³).

### Inventive Example 1 (E1)

A particulate filter having a TWC coat and a layer of inorganic particles having needle-like morphology was prepared.

A particulate filter having a TWC coat was firstly prepared by applying the same process as described in Reference Example 2 on the same blank filter as described in Reference Example 1. Then, the material B, boehmite powder, was mixed with a carrier gas and blown into the inlet channels of the filter at a flow rate of 600 m³/h at room temperature. After coating, the filter with the layer of inorganic particles in the inlet channels was calcined at a temperature of 550° C. for 1 hour. The loading of the layer of inorganic particles was 3 g/L (0.049 g/in³).

### Inventive Example 2 (E2)

A particulate filter having a TWC coat and a layer of inorganic particles having needle-like morphology was prepared.

A particulate filter having a TWC coat was first prepared by applying the same process as described in Reference Example 2 on the same blank filter as described in Reference Example 1. Then, the material C, alumina powder, was mixed with a carrier gas and blown into the inlet channels of the filter at a flow rate of 600 m³/h at room temperature. After coating, the filter with the layer of inorganic particles in the inlet channels was calcined at a temperature of 550° C. for 1 hour. The loading of layer of inorganic particles was 3 g/L (0.049 g/in³).

### Inventive Example 3 (E3)

A particulate filter having a TWC coat and a layer of inorganic particles having needle-like morphology was prepared.

A particulate filter having a TWC coat was firstly prepared by applying the same process as described in Reference Example 2 on the same blank filter as described in Reference Example 3. Then, the material B, boehmite powder, was mixed with a carrier gas and blown into the inlet channels of the filter at a flow rate of 600 m³/h at room temperature. After coating, the filter with the layer of inorganic particles in the inlet channels was calcined at a temperature of 550° C. for 1 hour. The loading of layer of inorganic particles was 1 g/L (0.016 g/in³).

### Inventive Example 4 (E4)

A particulate filter having a TWC coat and a layer of inorganic particles having needle or fiber morphology was prepared.

The preparation of the particulate filter was the same as Inventive Example 3, except that the loading of the layer of inorganic particles was 2 g/L (0.033 g/in³).

### II. Filtration Performance

### II.1 Back Pressure

The particulate filters of all the Examples were investigated for back pressure (BP), by measurement through a SuperFlow SF-1020 Flowbench under a cold air flow at 600 m³/h.

### II.2 Fresh Filtration Efficiency

The filtration efficiencies of the particulate filters from above Examples at fresh state (0 km, or out-of-box state) were measured, in accordance with the standard procedure defined in “BS EN ISO 29463-5: 2018—Part 5: Test method for filter elements”, on a stationary air filter performance testing bench with a cold air flow at 600 m³/h, using aerosol di(2-ethyl-hexyl) sebacate as particles. Particle number (PN) of particles ranging between 0.10 and 0.15 μm were recorded by a PN counter for both upstream and downstream of the filter being tested. The fresh filtration efficiency (FFE) was calculated in accordance with the equation

$$FFE = ( 1 - \frac{{PN}_{( downstream )}}{{PN}_{( upstream )}} ) \times 100 \%$$

The test results for each particulate filter from above Examples are summarized in Table 2 below.

TABLE 2

| | | TWC | Layer of | BP | FFE |
|---|---|---|---|---|---|
| Examples | Substrate | coating | Inorganic Particles | (mbar) | (%) |
| R1 | S1 | No | No | 45 | 72 |
| R2 | S1 | Yes | No | 53 | 66 |
| C1 | S1 | Yes | alumina from Material | 65 | 91 |
| | | | A, irregular shape, | | |
| | | | 5 g/L | | |
| E1 | S1 | Yes | alumina from Material | 63 | 96 |
| | | | B, needle-like, 3 g/L | | |
| E2 | S1 | Yes | alumina from Material | 58 | 92 |
| | | | C, needle-like, 3 g/L | | |
| R3 | S2 | Yes | No | 28 | 70 |
| C2 | S2 | Yes | alumina from Material | 29 | 79 |
| | | | A, irregular shape, | | |
| | | | 1 g/L | | |
| C3 | S2 | Yes | alumina from Material | 31 | 85 |
| | | | A, irregular shape, | | |
| | | | 2 g/L | | |
| E3 | S2 | Yes | alumina from Material | 29 | 88 |
| | | | B, needle-like, 1 g/L | | |
| E4 | S2 | Yes | alumina from Material | 31 | 92 |
| | | | B, needle-like, 2 g/L | | |

It can be seen from the comparison of Reference Example 1 (R1) vs. Reference Example 2 (R2) that the particulate filters with a TWC coat have a higher back pressure (BP) and lower fresh filtration efficiency (FFE) than the blank filter, which may be because the TWC components permeate into the porous walls of the substrate of the particulate filter. The fresh filtration efficiency (FFE) can be improved by applying a layer of alumina particles as shown in Comparative Example 1 (C1), with an acceptable increase of back pressure.

Surprisingly, the fresh filtration efficiency (FFE) can be improved to a greater extent by applying a layer of particles having needle-like morphology as shown in Inventive Example 1 (E1) which exhibits a fresh filtration efficiency of 96% with an acceptable increase of back pressure. Notably, the particulate filter of Inventive Example 1 (E1) exhibits a much higher fresh filtration efficiency with a lower back pressure than those of Comparative Example 1 (C1). Also, the particulate filter of Inventive Example 2 (E2) shows higher fresh filtration efficiency (FFE) with a much lower back pressure than that of Comparative Example 2 (C2).

The surprising improvements provided by using inorganic particles having needle-like morphology can also be observed from comparisons of Inventive Examples 3 and 4 with Comparative Examples 2 and 3. Notably, the particulate filter of Inventive Example 3 (E3) exhibits remarkably higher fresh filtration efficiency than Comparative Example 2 (C2), with the same back pressure. Also, the particulate filter of Inventive Example 4 (E4) exhibits remarkably higher fresh filtration efficiency than Comparative Example 3 (C3), with the same back pressure.

Although the invention herein has been described with reference to particular embodiments, it is to be understood that these embodiments are merely illustrative of the principles and applications of the present invention. It will be apparent to those of skill in the art that various modifications and variations can be made to the method and apparatus of the present invention without departing from the spirit and scope of the invention. Thus, it is intended that the present invention include modifications and variations that are within the scope of the appended claims and their equivalents.

1. A particulate filter, which comprises
a substrate, comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end; and
a layer of inorganic particles loaded on surfaces of porous walls in the inlet channels and/or outlet channels, preferably in at least the inlet channels,
wherein the layer of inorganic particles comprises inorganic particles of needle-like crystals.

2. The particulate filter according to claim 1, wherein the layer of inorganic particles comprises the inorganic particles of needle-like crystals in an amount of 50% by volume or higher, 75% by volume or higher, 85% by volume or higher, 90% by volume or higher, or even 95% by volume or higher.

3. The particulate filter according to claim 2, wherein the layer of inorganic particles substantially consists of the inorganic particles of needle-like crystals.

4. The particulate filter according to claim 1, wherein the layer of inorganic particles exhibits no three-way conversion catalytic activity.

5. The particulate filter according to claim 1, wherein the layer of inorganic particles does not comprise a PGM component.

6. The particulate filter according to claim 1, wherein the inorganic particles, particularly the inorganic particles of needle-like crystals are particles of a non-PGM inorganic material, particularly selected from alumina, hydrated alumina, boehmite, zirconia, ceria, silica, titania, magnesium oxide, zinc oxide, zinc carbonate, calcium oxide, calcium carbonate, silicate zeolite, aluminosilicate zeolite, or a combination or composite thereof.

7. The particulate filter according to claim 6, wherein the non-PGM inorganic material is selected from alumina, hydrated alumina, boehmite, silica, zinc oxide, zirconia, or a combination or composite thereof.

8. The particulate filter according to claim 1, wherein the needle-like crystals have a crystal length of no more than 20 μm, no more than 10 μm, or no more than 8 μm, as measured by a scanning electron microscope (SEM).

9. The particulate filter according to claim 1, wherein the needle-like crystals have a crystal thickness of no more than 1000 nm, no more than 500 nm, or no more than 300 nm, as measured by a scanning electron microscope (SEM).

10. The particulate filter according to claim 1, wherein the inorganic particles, particularly the inorganic particles of needle-like crystals, have a D90 of no more than 50 μm, no more than 30 μm, or no more than 20 μm.

11. The particulate filter according to claim 1, which further comprises a three-way conversion catalyst (TWC) coat, preferably a washcoat comprising a TWC composition.

12. The particulate filter according to claim 11, wherein the three-way conversion catalyst coat is in at least a portion of the inlet channels and/or outlet channels of the substrate.

13. The particulate filter according to claim 1, which comprises the layer of inorganic particles at a loading of from 0.3 to 50 g/L, from 0.6 to 20 g/L, or 0.9 to 6 g/L.

14. The particulate filter according to claim 1, which is a gasoline particulate filter.

15. A method for producing a particulate filter as defined in claim 1, which includes
providing a substrate comprising a plurality of porous walls extending longitudinally to form a plurality of parallel channels extending from an inlet end to an outlet end, wherein a quantity of the channels are inlet channels that are open at the inlet end and closed at the outlet end, and a quantity of channels are outlet channels that are closed at the inlet end and open at the outlet end,
applying inorganic particles or precursors thereof on surfaces of porous walls in the inlet channels and/or outlet channels, wherein at least part of the inorganic particles or precursors thereof are particles of needle-like crystals, and
optionally, drying and/or calcining.

16. The method according to claim 15, wherein the inorganic particles are applied by a dry coating or wash coating process, preferably by a dry coating process.

17. An exhaust treatment system, which comprises a particulate filter according to claim 1.

18. A method for treating an exhaust stream from a gasoline engine, which includes contacting the exhaust stream with a particulate filter according to claim 1.

19. An exhaust treatment system, which comprises a particulate filter obtainable or obtained from the method according to claim 13.

20. A method for treating an exhaust stream from a gasoline engine, which includes contacting the exhaust stream with a particulate filter obtainable or obtained from the method according to claim 15.
